(19) United States
(12) Patent Application Publication
(10) Pub. No.: US 2009/0132839 A1
(43) Pub. Date: May 21, 2009

(54) Method and device to handle denial of service attacks on wake events

(76) Inventors: Michael A. ROTHMAN, Puyallup, WA (US); Arvind KUMAR, Beaverton, OR (US); Vincent J. ZIMMER, Federal Way, WA (US); Patrick KUTCH, Beaverton, OR (US); Omer LEVY, Modiin (IL)

Correspondence Address: PEARL COHEN ZEDEK LATZER, LLP, 1500 BROADWAY, 12TH FLOOR, NEW YORK, NY, 10036, US

(21) Appl. No.: 11/984,320

(22) Filed: Nov. 15, 2007

(51) Int. Cl. G06F 1/32

(52) U.S. Cl. 713/320

(57) ABSTRACT

A method and device may selectively resume a computing device from a low power state according to a security policy. The security policy may be embedded in the hardware of the computing device and may be enforced even when the device is in a low power state. Such a policy may provide protection from hacker and virus based denial of service attacks using a flood of packets formatted to provide a wake event request. Other embodiments are described and claimed.

### BACKGROUND OF THE INVENTION

Increasing the energy efficiency of computer platforms has become a significant objective of research and development. Reducing power consumption in a computing device not only benefits the environment, but also results in substantial power cost savings to the user—around $100/year for a typical desktop computer system such as a personal computer (PC). These benefits are more pronounced in a network environment which may contain hundreds, if not thousands, of individual computer systems.

To conserve power in a networked environment, various technologies have been developed to allow networked computer systems to operate and be maintained in reduced power environments. One such technology, called Wake On LAN (WOL), allows a computer system in a reduced power state to be “woken up”, or booted, remotely by, for example, sending a special packet to that computer system's network adapter. Further enhancements, such as those provided by Intel® Active Management Technology, support common network management tasks, such as hardware/software asset tracking, remote diagnostics, and software update distribution, even when the computing system is in a reduced power state.

However, such power saving schemes do not protect against spurious or malicious wake events which may be created by a hacker or virus in an attempt to disrupt the target network, or to cause the target network to incur additional power costs. Current anti-virus countermeasures are not designed to protect against spurious network events, as these countermeasures do not operate in a reduced power state.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may be best understood by reference to the following detailed description when read with the accompanied drawings in which:

FIG. 1 is a block diagram of a computing network to be used with an embodiment of this invention.

FIG. 2 is a flowchart of a method to protecting against a denial of service attack using wake events, according to one embodiment of this invention.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer, processor, or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that the present invention may be used in a variety of applications. Although the present invention is not limited in this respect, the circuits and techniques disclosed herein may be used in many apparatuses such as personal computers, network equipment, stations of a radio system, wireless communication system, digital communication system, satellite communication system, and the like.

Stations, nodes and other devices intended to be included within the scope of the present invention include, by way of example only, local area network (LAN) stations and/or nodes, metropolitan area network (MAN) stations and/or nodes, personal computers, peripheral devices, wireless LAN stations, and the like.

Devices, systems and methods incorporating aspects of embodiments of the invention are also suitable for computer communication network applications, for example, intranet and Internet applications. Embodiments of the invention may be implemented in conjunction with hardware and/or software adapted to interact with a computer communication network, for example, a personal area network (PAN), LAN, wide area network (WAN), or a global communication network, for example, the Internet.

Embodiments of the invention may include a computer readable storage medium, such as for example a memory, a disk drive, or a “disk-on-key”, including instructions which when executed by a processor or controller, carry out methods disclosed herein.

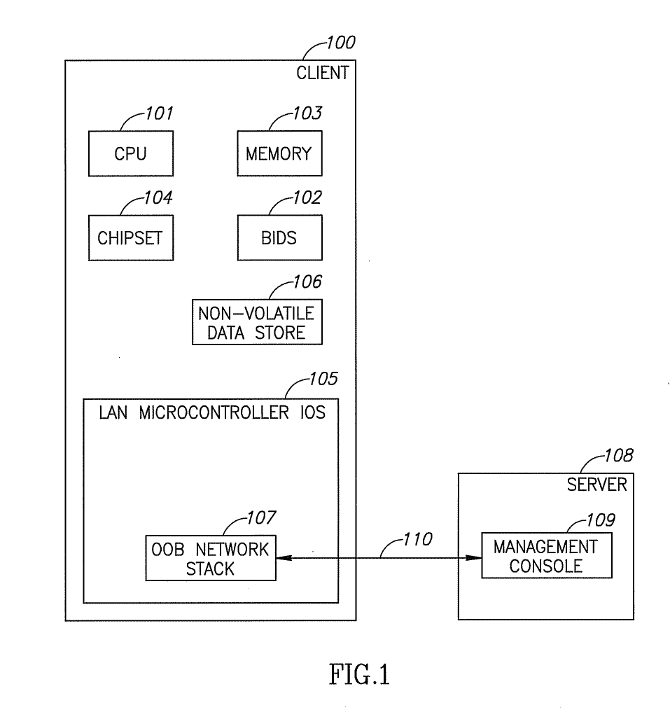

In FIG. 1, a computing network which may be used with an embodiment of the present invention is depicted. Client 100 may be any type of computing device (for example a PC, workstation, etc.) and may include CPU 101, which may be, for example, a single processor or controller, or a group of processors or processor cores sharing a common volatile memory 103 and/or non-volatile data store 106. BIOS 102 may identify and initiate hardware in the booting process, control low level functions such as clock and memory timings, and manage power settings. Chipset 104 is generally a motherboard-specific component, but may be integrated into CPU 101 or BIOS 102. Chipset 104 may be responsible for such functions as hardware monitoring, hardware control, and interfacing with BIOS 102 and/or software running on client 100.

Client 100 may also be equipped with a LAN microcontroller 105 which may be integrated into a network adapter (not shown) or be a standalone component. LAN microcontroller 105 may support such functionality as Wake On LAN, and may include an out-of-band networking stack 107 that allows client 100 to communicate with the rest of the network even when client 100 is in a reduced power state or experiences software (and/or certain hardware) failures.

Chipset 104, CPU 101, BIOS 102, volatile memory 103, and LAN microcontroller may be attached, connected or coupled, either directly or indirectly, through such motherboard or other interconnects as an internal bus, memory bus, PCI bus, frontside bus, etc. “Coupled” or “attached” in this sense, may mean connected by an information-transferring link such as a bus or other link, so that data may be transferred between components. A memory controller hub (e.g. Northbridge) and Input/Output controller hub (e.g. Southbridge) may also be employed.

Server 108 may be of similar configuration to that of client 100 except that server 108 may also include a management console 109 which may coordinate common network maintenance tasks remotely over a plurality of clients. Server 108 need not have the similar configuration of client 100. Such tasks may include hardware/software asset tracking, remote diagnostics, remote repair, software update distribution, and booting client 100 from a network resource. These tasks may be accomplished while client 100 is in a reduced power state. However, if necessary, server 108 may send a communication or message such as a special packet across network link 110 to a component such as an out-of-band network stack 107 in LAN microcontroller 105 to wake up client 100 from a reduced power state. In a preferred embodiment, the management console employs Intel® Active Management Technology, which may be either a software or hardware-based implementation, or a combination of the two. Other management console systems or methods may be used.

It is to be understood that the network depicted in FIG. 1 is merely the simplest configuration of a client-server network. Typical networks contain a multitude of clients and a plurality of servers, connected in a variety of topologies, as is well known in the computer networking art. Furthermore, the network may be comprised entirely of client machines, any of which may have functionality similar to that of management console 109.

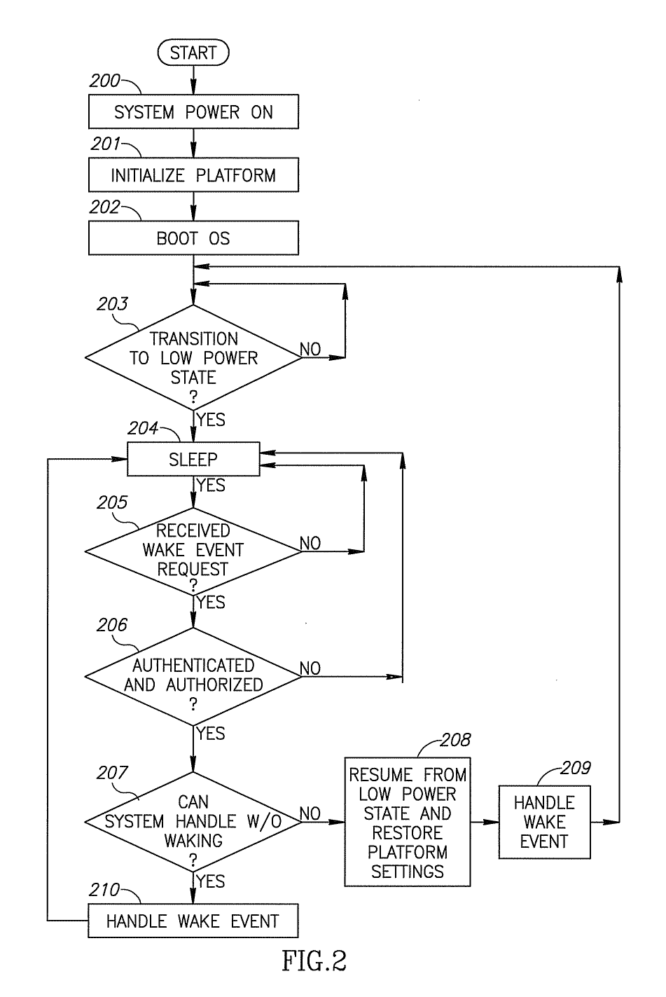

FIG. 2 shows a flowchart by which client 100 may securely respond to wake events in a reduced power state, according to one embodiment of the invention. In operation 200, client 100 is initially powered on. Client 100 then may initialize platform in operation 201. Such platform initialization may include a power on self test (POST). POST operations are usually handled by BIOS 102 and may include such actions as, for example: (1) verifying the integrity of the BIOS code itself, (2) determining the reason POST is being executed, (3) verifying system main memory, (4) discovering and initializing all system buses and devices, (4) passing control to other specialized BIOSes (if and when required), (5) providing a user interface for system's configuration, (6) identifying, organizing, and selecting which devices are available for booting, and (7) constructing whatever system environment that is required by the target operating system.

In operation 202, the operating system of client 100 is booted. In this booted state, client 100 may handle any request sent over a network without using out-of-band networking stack 107 embedded in LAN microcontroller 105. Instead, client 100 may employ a standard networking stack provided by the operating system itself.

In operation 203, client 100 may be operating normally in a full power state and may be awaiting an instruction to power down to a reduced power state. Such an instruction may come directly from for example the user (such user instruction may include for example a physical button push or closing of a laptop screen), or may be given by the operating system (or an application running thereon) in accordance with a given policy. For example, the operating system may give an instruction to power down to a reduced power state after a certain level of inactivity has been sustained for a given period. The instruction may also be given according to a set schedule, e.g., those hours in which an office is likely to be closed. Alternatively, the instruction may be given in response to a particular event, such as hardware or software failure, in which client 100 may be generally unusable until it has been serviced.

If an instruction to be powered down is given, client 100 may enter a sleep state, as shown in operation 204. Such a sleep state may be any of a variety of reduced power states or configurations, such as those defined by the Advanced Configuration and Power Interface (ACPI) specification (version 3.0b, released Oct. 10, 2006). The ACPI specification describes four such states:
S1 is the most power-hungry of sleep modes. All processor caches are flushed, and the CPU(s) stop executing instructions. Power to the CPU(s) and RAM is maintained; devices that do not indicate they must remain on may be powered down. Some newer machines do not support S1; older machines are more likely to support S1 than S3.
S2 is a deeper sleep state than S1, where the CPU is powered off; however, it is not commonly implemented.
S3 is called Standby in Windows™, Sleep in Mac OS X™, and sometimes also Suspend to RAM (STR), although the ACPI specification mentions only the terms S3 and Sleep. In this state, main memory (RAM) is still powered, although it is almost the only component that is. Since the state of the operating system and all applications, open documents, etc. lies all in main memory, the user can resume work exactly where he/she left off—the main memory content when the computer comes back from S3 is the same as when it was put into S3. (The specification mentions that S3 is rather similar to S2, only that some more components are powered down in S3.) S3 has two advantages over S4; the computer resumes in about the time it takes the monitor to come on, secondly if any running applications (opened documents, etc) have private information in them, this will not be written to the disk. However, disk caches may be flushed to prevent data corruption in case the system doesn't wake up e.g. due to power failure.
S4 is called Hibernation in Microsoft Windows™, Safe Sleep in Mac OS X™, and sometimes also Suspend to disk, although the ACPI specification mentions only the term S4. In this state, all content of main memory is saved to a hard drive, preserving the state of the operating system, all applications, open documents etc. That means that after coming back from S4, the user can resume work where it was left off in much the same way as with S3. The difference between S4 and S3, apart from the added time of moving the main memory content to disk and back, is that a power loss of a computer in S3 makes it lose all data in main memory, including all unsaved documents, while a computer in S4 is unaffected. S4 is quite different from the other S states and actually resembles G2 Soft Off and G3 Mechanical Off more than it resembles S1-S3.

Other sleep or reduced power states or protocols may be used.

In operation 205, client 100 receives a wake event request from the network. A wake event may be or include for example a request for a particular client or unit to perform a task, and may simply be a command for the client or unit to resume from a low power state. Tasks that may be performed in conjunction with a wake request or command may include, for example, data retrieval and transmission, data storage, and computation and transmission of the resulting output. Performing the task may include at least one or more operations in communication with the sender of the request.

Once this request is received, client 100 may implement a variety of security mechanisms to authenticate the request, as shown in operation 206. Such schemes may include transport layer security (TLS), HTTP authentication, enterprise-level authentication (Kerberos), access control lists (ACLs), and digital firmware signing. Some or all of these schemes may be built into LAN microcontroller 105 and/or chipset 104. By building these authentication schemes into such hardware devices, client 100 need not wake from a reduced power state to validate and process the network event. If such a request cannot be handled because it is not authentic or authorized, client 100 may remain in its sleep state. An inauthentic request may be for example a request that does not come from a trusted source, while an unauthorized request may come from a trusted source, for example, but may not comport with or be authorized by the client's particular security policy.

If, however, the wake event request is deemed authentic and authorized as determined by the security policy embedded in LAN microcontroller 105 and/or chipset 104, client 100 may proceed to operation 207, in which it may determine whether the wake event can be handled without waking up the system from its reduced power state. Such a determination may be based on the particular functionality built into chipset 104, BIOS 102, and LAN microcontroller 105. Actions such as reporting internal temperature, installed hardware and software information, and status information may generally be performed even in a reduced power state. Similarly, device firmware may be upgraded, and small software patches may be stored for later installation, if supported by the hardware of client 100.

However, such actions as upgrading/repairing the operating system or major software packages are generally not performed in a sleep state. In some computing systems, retrieving data from a non-volatile store 106, or performing a computationally intensive task using client 100 is generally not performed without waking from a sleep state. For embodiments in which a given task is not performed in a sleep state, client 100 may proceed to operation 208, where it resumes full power operation and restores platform settings from the point where it entered the sleep state. Alternatively, client 100, need not resume to a full power state, and need only resume to the highest level sleep state capable of handling the wake event.

Once client 100 resumes full power operation, it may proceed to operation 209, in which it may handle the wake event, and then may proceed back to operation 203, where it may await a further instruction to enter a reduced power state.

In one embodiment, determining whether a request is authentic, whether the request is authorized, and whether the request can be performed without waking the computing device, may be performed while the computing device is in a reduced power state. In one embodiment, waking the computing device may include raising the power state of computing device to the lowest power state capable of performing the task of the request.

Other operations or series of operations may be used.

The present invention has been described with certain degree of particularity. Those versed in the art will readily appreciate that various modifications and alterations may be carried out without departing from the scope of the following claims:

1. A method for selectively resuming a computing device from one of a plurality of reduced power states comprising:
receiving a request to wake the computing device over a network for a particular task;
determining whether the request to wake the computing device is authentic;
determining whether the request is authorized by a security policy;
determining whether the task can be performed without waking the computing device;
waking the computing device if the task cannot be performed in a reduced power state; and
performing the task including at least one or more operations in communication with the sender of the request,
wherein determining whether the request is authentic, whether the request is authorized, and whether the request can be performed without waking the computing device, is performed while the computing device is in the reduced power state.

2. The method of claim 1, wherein waking the computing device comprises raising the power state of computing device to the lowest power state capable of performing the task of the request.

3. The method of claim 1, comprising powering down to a reduced power state, if the computing device is not already in such a state, in response to an instruction from an operating system or hardware device.

4. The method of claim 1, wherein determining whether the request is authentic is performed by one or more of the following: transport layer security (TLS), HTTP authentication, enterprise-level authentication (Kerberos), access control lists (ACLs), and digital firmware signing.

5. The method of claim 1, wherein the reduced powered state comprises a state in which substantially all of the components of the computing device are powered down, except for a main memory unit, and wherein the data stored in the main memory comprises the state of the operating system, the state of all applications, and open documents.

6. The method of claim 1, wherein the reduced powered state comprises a state in which substantially all of the components of the computing device are powered down, and wherein the state of a main memory unit is stored in a non-volatile storage unit.

7. A computing device capable of selectively resuming a from a reduced power state comprising:
a processing unit;
a memory unit coupled to the processing unit;
a BIOS coupled to the memory unit and processing unit;
a chipset coupled to the memory unit, processing unit, and BIOS; and
a network adapter coupled to the memory unit, processing unit, BIOS, and chipset, including at least a network microcontroller and a out-of-band network stack,
wherein the computing device is to transition between one of a plurality of low power states and a wake state,
wherein the computing device is to evaluate the authenticity of a network request to wake from a reduced power state, and
wherein the computing device is to evaluate the authenticity of the network request in a reduced power state.

8. The computing device of claim 7, wherein one or more of the following is to evaluate the authenticity of a network request to wake: transport layer security (TLS), HTTP authentication, enterprise-level authentication (Kerberos), access control lists (ACLs), and digital firmware signing.

9. The computing device of claim 7, wherein the computing device is to determine whether the request to wake is authorized by a security policy.

10. The computing device of claim 8, wherein the computing device is to wake from a reduced power state in response to an authenticated and authorized request.

11. The computing device of claim 10, wherein waking the computing device comprises raising the power state of the computing device to the lowest power state capable of performing a task associated with the request.

12. The computing device of claim 10, wherein the computing device is to further power down to a reduced power state, if the computing device is not already in such a state, in response to an instruction from an operating system or hardware device.

13. The computing device of claim 7, wherein the reduced powered state comprises a state in which substantially all of the components of the computing device is powered down, except for a main memory unit, and wherein the data stored in the main memory comprises the state of the operating system, the state of all applications, and open documents.

14. The computing device of claim 7, wherein the reduced powered state comprises a state in which substantially all of the components of the computing device is powered down, and wherein the state of a main memory unit is stored in a non-volatile storage unit.

15. A processor-readable storage medium having stored thereon instructions that, if executed by a processor, cause the processor to perform a method comprising:
receiving a request to wake a computing device over a network for a particular task;
determining whether the request to wake the computing device is authentic;
determining whether the request is authorized by a security policy;
determining whether the task can be performed without waking the computing device;
waking the computing device if the task cannot be performed in one of a plurality of reduced power states; and
performing the task including at least one or more operations in communication with the sender of the request,
wherein determining whether the request is authentic, whether the request is authorized, and whether the request can be performed without waking the computing device, is performed while the computing device is in a reduced power state.

16. The processor-readable storage medium of claim 15, wherein waking the computing device comprises raising the power state of computing device to the lowest power state capable of performing the task of the request.

17. The processor-readable storage medium of claim 15, further comprising powering down to a reduced power state, if the computing device is not already in such a state, in response to an instruction from an operating system or hardware device.

18. The processor-readable storage medium of claim 15, wherein determining whether the request is authentic is performed by one or more of the following: transport layer security (TLS), HTTP authentication, enterprise-level authentication (Kerberos), access control lists (ACLs), and digital firmware signing.
